(19) United States
(12) Patent Application Publication
(10) Pub. No.: US 2024/0288855 A1
(43) Pub. Date: Aug. 29, 2024

(54) FLEXIBLE JOB-SHOP SCHEDULING METHOD AND SYSTEM AND ELECTRONIC DEVICE

(71) Applicant: Beijing Institute of Technology, Beijing (CN)

(72) Inventors: Jian SUN, Beijing (CN); Runqing WANG, Beijing (CN); Gang WANG, Beijing (CN); Minggang GAN, Beijing (CN); Jie CHEN, Beijing (CN)

(73) Assignee: Beijing Institute of Technology, Beijing (CN)

(21) Appl. No.: 18/215,266

(22) Filed: Jun. 28, 2023

(30) Foreign Application Priority Data
Feb. 28, 2023 (CN) 2023101992253

(51) Int. Cl. G05B 19/418

(52) U.S. Cl. CPC G05B 19/41865; G05B 19/4183

(57) ABSTRACT

The present disclosure provides a flexible job-shop scheduling method and system and an electronic device. The method according to the present disclosure includes: randomly generating a plurality of flexible job-shop environments in a production job-shop according to a preset production target; constructing a scheduling strategy model of the production job-shop based on a Markov decision process; optimizing a feature extraction network, an actor network and a critic network simultaneously by using the scheduling strategy model and a plurality of data sets, and determining a scheduling plan corresponding to a maximum completion time as an optimal scheduling plan after the completion of the optimization; and completing the preset production target based on the optimal scheduling plan. According to the present disclosure, feature extraction is performed on the plurality of job-shop environments to generate a scheduling scheme, so as to improve the efficiency and rationality of flexible job-shop scheduling.

### CROSS REFERENCE TO RELATED APPLICATION

This patent application claims the benefit and priority of Chinese Patent Application No. 2023101992253, filed with the China National Intellectual Property Administration on Feb. 28, 2023, the disclosure of which is incorporated by reference herein in its entirety as part of the present application.

### TECHNICAL FIELD

The present disclosure relates to the technical field of intelligent scheduling of discrete manufacturing, and in particular, to a flexible job-shop scheduling method and system and an electronic device.

### BACKGROUND

Manufacturing intelligence is a main direction of innovation drive and transformation and upgrading in China's manufacturing industry, and intelligent production scheduling is a key path to implement manufacturing intelligence. In manufacturing industry, the production capacity of enterprises is closely related to a resource scheduling strategy used. Currently, due to increasingly fierce market competition and complex and changeable customer needs, a scheduling system having real-time performance, universality, flexibility and expansibility is needed to arrange production tasks, so as to implement efficient utilization of production resources and maximize production benefits. Therefore, it is of great theoretical significance and economic value to study a method for intelligent optimal scheduling and independent decision-making of discrete manufacturing. Flexible job-shop scheduling problem (FJSP), as a generalization of a job-shop scheduling problem (JSP), is a general scheduling problem, and attracts much attention from the industry because the FJSP meets requirements of production flexibility and diversity in an actual production scenario.

Conventional methods for solving the production scheduling problem mainly include accurate methods, meta-heuristic algorithms, and heuristic methods. These methods have certain application bottlenecks. For example, the accurate methods such as a branch and bound method and a mathematical programming method can solve an optimal solution of an original problem, but usually have exponential computational complexity and cannot meet requirements of real-time scheduling in actual production scenarios. The meta-heuristic algorithms such as a genetic algorithm and a particle swarm optimization algorithm are widely used, but the meta-heuristic algorithms are sensitive in performance to parameters and have poor generalization. The heuristic methods refer to a type of methods of solving by presetting rules to an original problem based on prior knowledge, which have simpleness in program realization and good real-time performance and generalization, but the quality of solutions generated by the methods is often not good enough, and the methods can only adapt to some specific scenarios.

In recent years, a deep reinforcement learning method shows advantages in many fields, including the combinatorial optimization field including the scheduling problem. The reinforcement learning method models a scheduling task as a Markov decision process (MDP), and supports a lot of exploration and learning by an agent in a simulated job-shop environment. The method is a data-driven method that can be implemented in an offline environment. In addition, when the agent applies a learned strategy in an actual environment, the agent can quickly give an evaluated amount at a small time cost. Therefore, this method has the advantages of data learning and real-time decision-making, and effectively overcomes the shortcomings of conventional methods. In addition, to make a decision-making model have the generalization ability to solve scheduling problems of different scales, scholars apply different state representation methods to the design of the model, and successfully apply the state representation methods to the flexible job-shop scheduling problem of optimizing a minimum completion time. Han et al. have used an improved pointer network to encode and decode process information to be scheduled, and designed a scheduling decision method based on a pointer network and a strategy gradient algorithm. Lei et al. have designed a feature extraction method based on an isomorphic graph, learned a flexible job-shop environment represented based on a disjunctive graph, divided the decision into two steps: process selection and machine selection, and set up two agents to handle these two steps respectively. Song et al. have proposed a heterogeneous disjunctive graph method to describe a flexible job-shop environment, and designed an end-to-end scheduling strategy model based on a heterogeneous graph neural network and a proximal policy optimization algorithm, and the model is superior to simple scheduling rules and meta-heuristic algorithms in quality of solutions. However, although the scheduling methods listed above can be used to solve the flexible job-shop scheduling problem, there are still some problems, mainly in the aspects of insufficient learning of features of production units and insufficient exploration of the flexible job-shop environment, and there is room for improvement in the quality of solutions, computational efficiency, generalization ability, etc.

### SUMMARY

An objective of the present disclosure is to provide a flexible job-shop scheduling method and system and an electronic device, which can perform feature extraction on a plurality of job-shop environments to generate a scheduling scheme, so as to improve the efficiency and rationality of flexible job-shop scheduling.

To achieve the above objective, the present disclosure provides the following technical solutions.

A flexible job-shop scheduling method is provided, including:

randomly generating a plurality of flexible job-shop environments in a production job-shop according to a preset production target, and constructing a plurality of data sets according to parameters of the plurality of flexible job-shop environments, where the data sets are in a one-to-one correspondence with the flexible job-shop environments, and the data sets each are a training set or a validation set:
constructing a scheduling strategy model of the production job-shop based on a Markov decision process;
performing parameter initialization processing on a feature extraction network, an actor network, and a critic network;
optimizing the feature extraction network, the actor network and the critic network simultaneously by using the scheduling strategy model and the plurality of data sets, and determining a scheduling plan corresponding to a maximum completion time as an optimal scheduling plan after the completion of the optimization; and
completing the preset production target based on the optimal scheduling plan.

Optionally, the optimizing the feature extraction network, the actor network and the critic network simultaneously by using the scheduling strategy model and the plurality of data sets, and determining a scheduling plan corresponding to a maximum completion time as an optimal scheduling plan after the completion of the optimization includes:
determining an initialized feature extraction network parameter, actor network parameter and critic network parameter as network parameters of a 0^{th} training round;
initializing an evaluated amount of the 0^{th} training round;
letting a number of training rounds be Episode=1;
initializing a cache pool and capacity of the scheduling strategy model;
letting a first iteration number be i=1;
determining any training flexible job-shop environment in a training flexible job-shop environment set as a current training flexible job-shop environment, where the training flexible job-shop environment is a flexible job-shop environment corresponding to a training set;
determining a process diagram and a machine competition graph of the current training flexible job-shop environment;
updating the cache pool by using the feature extraction network, the actor network and the critic network according to the process diagram and the machine competition graph;
performing parameter update on the feature extraction network, the actor network and the critic network by using a gradient descent method according to the cache pool; and determining whether the number of training rounds Episode reaches a threshold of round iterations to obtain a first determining result;
determining, if the first determining result is no, whether the first iteration number i is an integer multiple of the number of training flexible job-shop environments to obtain a second determining result;
updating, if the second determining result is no, the current training flexible job-shop environment, increasing a value of the first iteration number i by 1, and returning to the step of determining a process diagram and a machine competition graph of the current training flexible job-shop environment;
determining, if the second determining result is yes, an updated parameter of the feature extraction network, an updated parameter of the actor network and an updated parameter of the critic network as to-be-determined network parameters of an Episode^{th} training round;
determining a current strategy according to the cache pool, validating the current strategy by using a plurality of validation sets, and determining an evaluated amount of the Episode^{th} training round;
determining a network parameter of the Episode^{th} training round according to the evaluated amount of the Episode^{th} training round, an evaluated amount of an (Episode-1)th training round, a to-be-determined network parameter of the Episode^{th} training round and a network parameter of the (Episode-1)th training round: updating the training flexible job-shop environment set: increasing the value of the number Episode of training rounds by 1, increasing the value of the first iteration number i by 1, and returning to the step of determining any training flexible job-shop environment in a training flexible job-shop environment set as a current training flexible job-shop environment; and
determining, if the first determining result is yes, that the optimization on the feature extraction network, the actor network and the critic network is completed, and determining the scheduling plan corresponding to the maximum completion time as the optimal scheduling plan.

Optionally, the process diagram is used to describe processes capable of being completed in the flexible job-shop environment, process features capable of being completed in the flexible job-shop environment, a sequence of processes of a same workpiece, and a sequence of a plurality of processes completed on a same machine when the same workpiece is produced; and
where the process feature includes a scheduling mark of a process in a current state, an estimated lower bound of a completion time, a processing time span, an average processing time, a queuing time, a number of remaining processes of a workpiece, a remaining workload of the workpiece, and a number of machinable machines.

Optionally, the machine competition graph includes a plurality of machines in a flexible job-shop environment, machine features of the plurality of machines in the flexible job-shop environment, and a competition relationship between the plurality of machines; and
the machine feature includes a number of machinable candidates of a machine in the current state, a total number of machinable processes, an average processing time, a queuing time, an idle time, and a current queue length.

Optionally, the updating the cache pool by using the feature extraction network, the actor network and the critic network according to the process diagram and the machine competition graph includes:
initializing state information of an 0th iteration;
initializing a process feature map and a machine feature map;
letting a second iteration number bet=1;
acquiring state information in a (t-1)^{th} iteration;
inputting the state information in the (t-1)^{th} iteration into the feature extraction network to
obtain process features and machine features;
updating the process feature map by using the process features;
updating the machine feature map by using the machine features;
inputting the process feature map and the machine feature map into the actor network to obtain a scheduling strategy in the (t-1)^{th} iteration;
sampling the scheduling strategy in the (t-1)^{th} iteration to obtain an action when the (t-1)^{th} iteration is generated;
using the action in the (t-1)^{th} iteration to interact with the current training flexible job-shop environment, to obtain an iteration reward and state information in the t^{th} iteration;
inputting the process feature map and the machine feature map into the critic network to obtain an advantage function value;
adding the state information in the (t-1)^{th} iteration, the action in the (t-1)^{th} iteration, the iteration reward, the state information in the t^{th} iteration and the advantage function value to the cache pool;
determining whether the second iteration number t satisfies the current training flexible job-shop environment, to obtaining a third determining result;
adding, if the third determining result is yes, the total number of the processes of the current training flexible job-shop as a termination mark to the cache pool; and
increasing, if the third determining result is no, the value of the second iteration number t by 1, and returning to the step of acquiring state information in the (t-1)^{th} iteration.

Optionally, the determining a current strategy according to the cache pool, validating the current strategy by using a plurality of validation sets, and determining an evaluated amount of the Episode^{th} training round includes:
allowing the current strategy to interact with a plurality of validating flexible job-shop environments in a validating flexible job-shop environment set to obtain a maximum completion time corresponding to each validating flexible job-shop environment, where the validating flexible job-shop environment is a flexible job-shop environment corresponding to the validation set; and
determining an average value of a plurality of maximum completion times corresponding to the validating flexible job-shop environment set as an evaluated amount of the Episode^{th} training round.

Optionally, the determining a network parameter of the Episode^{th} training round according to the evaluated amount of the Episode^{th} training round, an evaluated amount of an (Episode-1)^{th} training round, a to-be-determined network parameter of the Episode^{th} training round and a network parameter of the (Episode-1)^{th} training round includes:
determining whether the evaluated amount of the Episode^{th} training round is greater than that of the (Episode-1)^{th} training round to obtain a fourth determining result; and
determining, if the fourth determining result is yes, the to-be-determined network parameter of the Episode^{th} training round as a network parameter of the Episode^{th} training round; or
determining, if the fourth determining result is no, the network parameter of the (Episode-1)^{th} training round as a network parameter of the Episode^{th} training round.

A flexible job-shop scheduling system is provided, including:
a flexible job-shop environment generating module, configured to randomly generate a plurality of flexible job-shop environments in a production job-shop according to a preset production target, and construct a plurality of data sets according to parameters of the plurality of flexible job-shop environments, where the data sets are in a one-to-one correspondence with the flexible job-shop environments, and the data sets each are a training set or a validation set;
a scheduling strategy model determining module, configured to construct a scheduling strategy model of the production job-shop based on a Markov decision process;
a network parameter initialization module, configured to perform parameter initialization processing on a feature extraction network, an actor network, and a critic network;
an optimal scheduling plan determining module, configured to optimize the feature extraction network, the actor network and the critic network simultaneously by using the scheduling strategy model and the plurality of data sets, and determine a scheduling plan corresponding to a maximum completion time as an optimal scheduling plan after the completion of the optimization; and
a scheduling module, configured to complete the preset production target based on the optimal scheduling plan.

An electronic device is provided, including a memory and a processor, where the memory is configured to store a computer program, and the processor runs the computer program to enable the electronic device to implement the above-described flexible job-shop scheduling method.

Optionally, the memory is a readable storage medium.

According to the embodiments of the present disclosure, the present disclosure has the following technical effects:

The present disclosure provides a flexible job-shop scheduling method and system and an electronic device. The method includes: randomly generating a plurality of flexible job-shop environments in a production job-shop according to a preset production target: constructing a plurality of data sets according to parameters of the plurality of flexible job-shop environments, where the data sets are in a one-to-one correspondence with the flexible job-shop environments, and the data sets each are a training set or a validation set: constructing a scheduling strategy model of the production job-shop based on a Markov decision process: performing parameter initialization processing on a feature extraction network, an actor network, and a critic network; optimizing the feature extraction network, the actor network and the critic network simultaneously by using the scheduling strategy model and the plurality of data sets, and determining a scheduling plan corresponding to a maximum completion time as an optimal scheduling plan after the completion of the optimization; and completing the preset production target based on the optimal scheduling plan. According to the present disclosure, feature extraction is performed on the plurality of job-shop environments to generate a scheduling scheme, so as to improve the efficiency and rationality of flexible job-shop scheduling.

### BRIEF DESCRIPTION OF THE DRAWINGS

To describe the technical solutions in embodiments of the present disclosure or in the prior art more clearly, the accompanying drawings required in the embodiments are briefly described below. Apparently, the accompanying drawings in the following description show merely some embodiments of the present disclosure, and other accompanying drawings can be derived from these accompanying drawings by those of ordinary skill in the art without creative efforts.

FIG. 1 is a flowchart of a flexible job-shop scheduling method according to the present disclosure;

FIG. 2 is a schematic diagram of a process according to the present disclosure:

FIG. 3 is a schematic diagram of machine competition according to the present disclosure:

FIG. 4 is a schematic diagram of a feature extraction model based on a graph neural network according to the present disclosure:

FIG. 5 is a schematic diagram of a state transition process of a Markov decision model according to the present disclosure:

FIG. 6 is a principle diagram of a flexible job-shop scheduling method according to the present disclosure:

FIG. 7 is a schematic diagram of a production Gantt chart according to the present disclosure:

FIG. 8 is a diagram showing an operation effect in a flexible job-shop environment in a 3×3×9 scale according to the present disclosure:

FIG. 9 is a diagram showing an operation effect in a flexible job-shop environment in a 6×6×36 scale according to the present disclosure:

FIG. 10 is a diagram showing an operation effect in a flexible job-shop environment in a 10×5×50 scale according to the present disclosure; and

FIG. 11 is a diagram showing an operation effect in a flexible job-shop environment in a 20×5×100 scale according to the present disclosure.

FIG. 12 is a schematic diagram of the electronic equipment used to implement the flexible job-shop scheduling method.

### DETAILED DESCRIPTION OF THE EMBODIMENTS

The technical solutions of the embodiments of the present disclosure are clearly and completely described below with reference to the accompanying drawings in the embodiments of the present disclosure. Apparently, the described embodiments are merely some rather than all of the embodiments of the present disclosure. All other embodiments obtained by those of ordinary skill in the art based on the embodiments of the present disclosure without creative efforts shall fall within the protection scope of the present disclosure.

An objective of the present disclosure is to provide a flexible job-shop scheduling method and system and an electronic device, which can perform feature extraction on a plurality of job-shop environments to generate a scheduling scheme, so as to improve the efficiency and rationality of flexible job-shop scheduling.

To make the above objectives, features, and advantages of the present disclosure clearer and more comprehensible, the present disclosure will be further described in detail below with reference to the accompanying drawings and the specific implementations.

### Embodiment 1

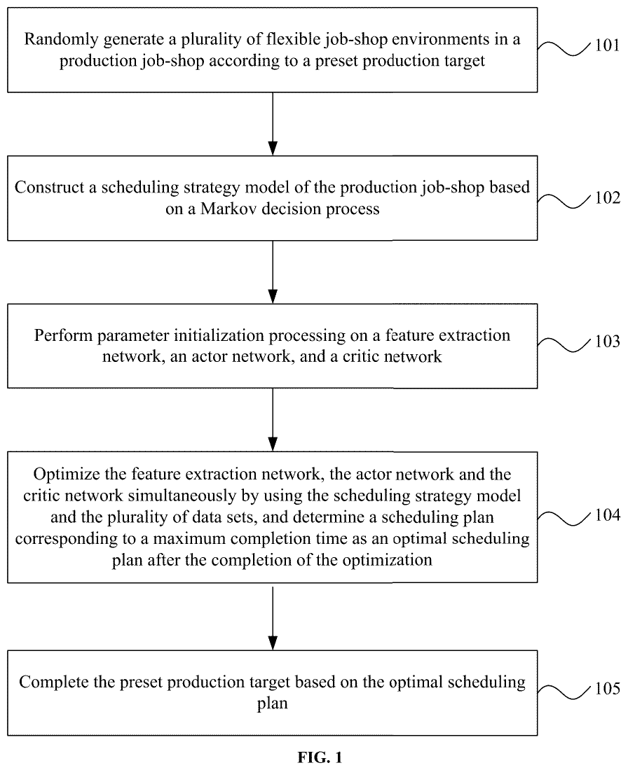

As shown in FIG. 1, this embodiment provides a flexible job-shop scheduling method, including the following steps.

Step 101: Randomly generate a plurality of flexible job-shop environments in a production job-shop according to a preset production target, and construct a plurality of data sets according to parameters of the plurality of flexible job-shop environments, where the data sets are in a one-to-one correspondence with the flexible job-shop environments, and the data sets each are a training set or a validation set.

Step 102: Construct a scheduling strategy model of the production job-shop based on a Markov decision process.

Step 103: Perform parameter initialization processing on a feature extraction network, an actor network, and a critic network.

Step 104: Optimize the feature extraction network, the actor network and the critic network simultaneously by using the scheduling strategy model and the plurality of data sets, and determine a scheduling plan corresponding to a maximum completion time as an optimal scheduling plan after the completion of the optimization.

Step 104 includes the following steps.

Step 1041: Determine an initialized feature extraction network parameter, actor network parameter and critic network parameter as network parameters of a 0^{th} training round.

Step 1042: Initialize an evaluated amount of the 0^{th} training round.

Step 1043: Let a number of training rounds be Episode=1.

Step 1044: Initialize a cache pool and capacity of the scheduling strategy model.

Step 1045: Let a first iteration number be i=1.

Step 1046: Determine any training flexible job-shop environment in a training flexible job-shop environment set as a current training flexible job-shop environment, where the training flexible job-shop environment is a flexible job-shop environment corresponding to a training set.

Step 1047: Determine a process diagram and a machine competition graph of the current training flexible job-shop environment. The process diagram is used to describe processes that can be completed in the flexible job-shop environment, process features that can be completed in the flexible job-shop environment, a sequence of processes of a same workpiece, and a sequence of a plurality of processes completed on a same machine when the same workpiece is produced, where the process feature includes a scheduling mark of a process in a current state, an estimated lower bound of a completion time, a processing time span, an average processing time, a queuing time, a number of remaining processes of a workpiece, a remaining workload of the workpiece, and a number of machinable machines. The machine competition graph includes a plurality of machines in a flexible job-shop environment, machine features of the plurality of machines in the flexible job-shop environment, and a competition relationship between the plurality of machines; and the machine feature includes a number of machinable candidates of a machine in the current state, a total number of machinable processes, an average processing time, a queuing time, an idle time, and a current queue length.

Step 1048: Update the cache pool by using the feature extraction network, the actor network and the critic network according to the process diagram and the machine competition graph.

Step 1048 includes the following steps:

Step 10481: Initialize state information of an 0^{th} iteration.

Step 10482: Initialize a process feature map and a machine feature map.

Step 10483: Let a second iteration number be t=1.

step 10484: Acquire state information in the (t-1)^{th} iteration.

Step 10485: Input the state information in the (t-1)^{th} iteration into the feature extraction network to obtain process features and machine features.

Step 10486: Update the process feature map by using the process features.

Step 10487: Update the machine feature map by using the machine features.

Step 10488: Input the process feature map and the machine feature map into the actor network to obtain a scheduling strategy in the (t-1)^{th} iteration.

Step 10489: Sample the scheduling strategy in the (t-1)^{th} iteration to obtain an action when the (t-1)^{th} iteration is generated.

Step 104810: Use the action in the (t-1)^{th} iteration to interact with the current training flexible job-shop environment, to obtain an iteration reward and state information in the t^{th} iteration.

Step 104811: Input the process feature map and the machine feature map into the critic network to obtain an advantage function value.

Step 104812: Add the state information in the (t-1)^{th} iteration, the action in the (t-1)^{th} iteration, the iteration reward, the state information in the t^{th} iteration and the advantage function value to the cache pool.

Step 104813: Determine whether the second iteration number t satisfies the current training flexible job-shop environment, to obtaining a third determining result.

Step 104814: Add, if the third determining result is yes, the total number of the processes of the current training flexible job-shop as a termination mark to the cache pool.

Step 104815: Increase, if the third determining result is no, the value of the second iteration number t by 1, and return to the step of acquiring state information in a (t-1)^{th} iteration.

Step 1049: Perform parameter update on the feature extraction network, the actor network and the critic network by using a gradient descent method according to the cache pool; and determine whether the number of training rounds Episode reaches a threshold of round iterations to obtain a first determining result.

Step 10410: Determine, if the first determining result is no, whether the first iteration number i is an integer multiple of the number of training flexible job-shop environments to obtain a second determining result.

Step 10411: Update, if the second determining result is no, the current training flexible job-shop environment, increase a value of the first iteration number i by 1, and return to the step of determining a process diagram and a machine competition graph of the current training flexible job-shop environment.

Step 10412: Determine, if the second determining result is yes, an updated parameter of the feature extraction network, an updated parameter of the actor network and an updated parameter of the critic network as to-be-determined network parameters of an Episode^{th} training round.

Step 10413: Determine a current strategy according to the cache pool, validate the current strategy by using a plurality of validation sets, and determine an evaluated amount of the Episode^{th} training round.

Step 10413 includes the following steps.

Step 104131: Allow the current strategy to interact with a plurality of validating flexible job-shop environments in a validating flexible job-shop environment set to obtain a maximum completion time corresponding to each validating flexible job-shop environment, where the validating flexible job-shop environment is a flexible job-shop environment corresponding to the validation set.

Step 104132: Determine an average value of a plurality of maximum completion times corresponding to the validating flexible job-shop environment set as an evaluated amount of the Episode^{th} training round.

Step 10414: Determine a network parameter of the Episode^{th} training round according to the evaluated amount of the Episode^{th} training round, an evaluated amount of an (Episode-1)^{th} training round, a to-be-determined network parameter of the Episode^{th} training round and a network parameter of the (Episode-1)^{th} training round: update the training flexible job-shop environment set: increase the value of the number Episode of training rounds by 1, increase the value of the first iteration number i by 1, and return to the step of determining any training flexible job-shop environment in a training flexible job-shop environment set as a current training flexible job-shop environment.

Step 10414 includes the following steps.

Step 104141: Determine whether the evaluated amount of the Episode^{th} training round is greater than that of the (Episode-1)^{th} training round to obtain a fourth determining result.

Step 104142: Determine, if the fourth determining result is yes, the to-be-determined network parameter of the Episode^{th} training round as a network parameter of the Episode^{th} training round.

Step 104143: Determine, if the fourth determining result is no, the network parameter of the (Episode-1)^{th} training round as a network parameter of the Episode^{th} training round.

Step 10415: Determine, if the first determining result is yes, that the optimization on the feature extraction network, the actor network and the critic network is completed, and determine the scheduling plan corresponding to the maximum completion time as the optimal scheduling plan.

Step 105: Complete the preset production target based on the optimal scheduling plan.

### Embodiment 2

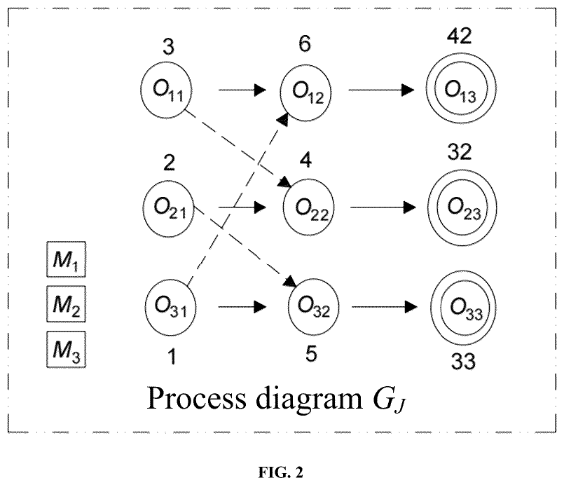

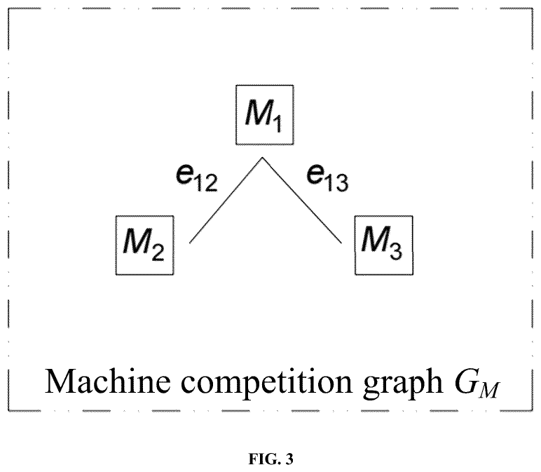

A modeling method of a flexible job-shop environment diagram according to the present disclosure is shown in FIGS. 2 and 3, and processes and machines are described by means of a process diagram and a machine competition graph respectively. The process diagram is defined as G_{J}= [symbol] V_{J}, E_{J}, F_{J} [symbol] , where V_{J} is a node set G_{J}, and corresponds to processes in the job-shop: E_{J} is an edge set of G_{J}, which is composed of two types of edges, one type is used to represent a processing sequence of processes of a same workpiece, and the other type is used to represent a processing sequence of processes on the same machine: F_{J} is a feature set of a node in G_{J}, and features of each process are represented by an 8-dimensional vector, which includes a scheduling mark of the process in a current state, an estimated lower bound of a completion time, a processing time span, an average processing time, a queuing time, a number of remaining processes of a workpiece, a remaining workload of the workpiece, and a number of machinable machines. The machine competition graph is defined as G_{M}= [symbol] V_{M}, E_{M}, F_{M}, F_{E}_{_{M}} [symbol] , where V_{M} is a node set of G_{M}, and corresponds to machines in the job-shop: E_{M} is an edge set of G_{M}, which connects machines having a processing competition relationship by using undirected edges: F_{M} is a feature set of nodes in G_{M}, and features of each machine are represented by a 6-dimensional vector, which includes a number of machinable candidates of the machine in the current state, a total number of machinable processes, an average processing time, a queuing time, an idle time, and a current queue length: F_{E}_{_{M}} is an edge feature set of G_{M}, and features of an edge are defined as the sum of features of processes that the nodes at two ends of the edge compete for. Production unit information and job-shop structure information can be fully described based on the above defined modeling method of a flexible job-shop diagram.

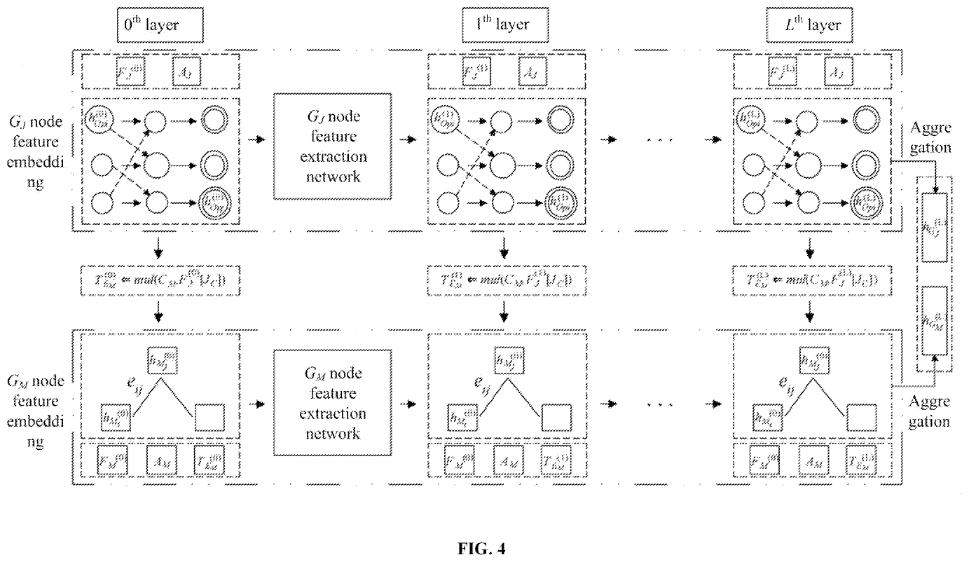

A feature extraction model based on a graph neural network according to the present disclosure is shown in FIG. 4. The model learns process features and machine features by using a graph attention network and an edge feature graph attention network respectively, and enables features of processes and machine nodes to interact during network iteration according to a production relationship: at an l^{th} layer of the network, a process node feature set F_{J}^{(l)} and an adjacency matrix A_{J} of G_{J} of this layer are inputted to a graph attention network (GAT) module GAT^{(l)} of this layer, to obtain a process node feature set F_{J}^{(l+1)} of a next layer. in addition, an edge feature mapping tensor T_{E}_{_{M}}^{(l)} of the l^{th} layer of G_{M} is calculated according to the edge set E_{M} of G_{M} and a to-be-scheduled process in the current state, F_{E}_{_{M}}^{(l)} is calculated by using T_{E}_{_{M}}^{(l)} and F_{J}^{(l)}, and then a machine node feature set F_{M}^{(l)}, an adjacency matrix A_{M} of G_{M} and F_{E}_{_{M}}^{(l)} of this layer are inputted into an edge graph attention network (EGAT) EGAT^{(l)} of this layer, to obtain a machine node feature set F_{M}^{(l+1)} of the next layer. The feature extraction model defined in this way can learn more abundant node features.

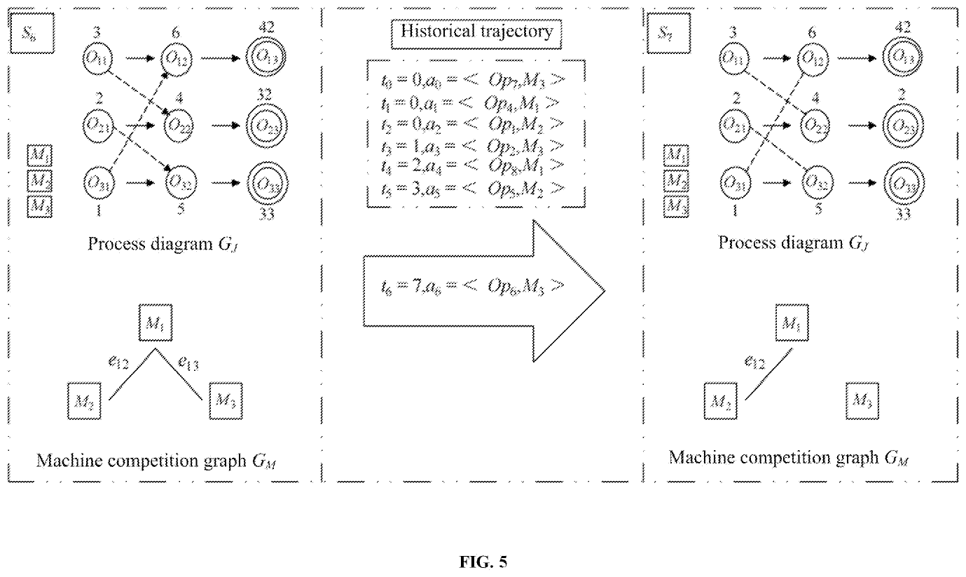

A state transition process in a Markov decision model for scheduling tasks according to the present disclosure is shown in FIG. 5. After a scheduling action of each step is completed, a next scheduling time can be calculated according to existing scheduling information, and environmental information can be updated to this time. Specifically, for the process diagram, a process feature set F_{J} may be recalculated according to the environmental information, and for a machine selected in the current step, a previous process thereof is connected to a process selected in the current step, that is, a new edge is generated in the process diagram: for the machine competition graph, a machine feature set F_{M} may be recalculated according to the environmental information, and in addition, because a competition relationship between machines changes after the state update, an edge set E_{M} is also regenerated. The state transition process defined in this way makes full use of a relationship between nodes that dynamically changes during production, which helps an agent to perceive the environment.

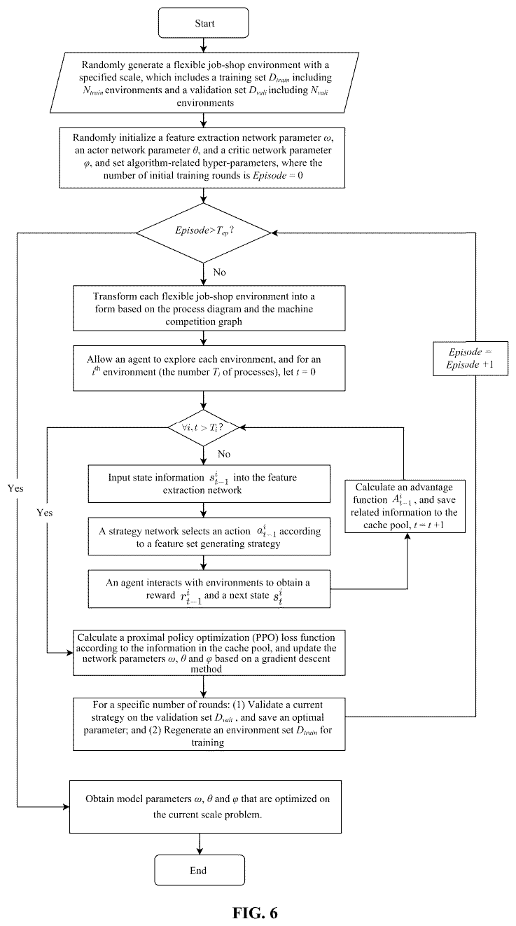

As shown in FIG. 6, an embodiment of the present disclosure provides a flexible job-shop scheduling method based on dual-view graph reinforcement learning, including the following steps.

S1: Randomly initialize a feature extraction network parameter ω, an actor network parameter θ, and a critic network parameter φ: randomly generate a flexible job-shop environment with a specified scale, which includes a training set Dₜᵣₐᵢₙ including Nₜᵣₐᵢₙ environments and a validation set Dᵥₐₗᵢ including Nᵥₐₗᵢ environments; and set algorithm-related hyper-parameters: a number L_{fea} of iterations of a feature extraction network, a number dₒᵤₜ of feature dimension of an output node, a number L_{agent} of layers and a number d_{agent} of dimensions of an actor network and a critic network, etc.

S2: If a number of training times reaches a preset value Tₑₚ, end training: otherwise, transform each flexible job-shop environment into a form based on the process diagram and the machine competition graph: collect data of an i^{th} environment, generate a node set (V_{J})₀ⁱ and an edge set (E_{J})₀ⁱ according to the number of processes and a workpiece which the processes pertain to, generate feature sets (F_{J})₀ⁱ and (F_{M})₀ⁱ according to a production time and a processing relationship, and then generate a node set (V_{M})₀ⁱ an edge set (E_{M})₀ⁱ and an edge feature set (F_{E}_{_{M}})₀ⁱ according to the number of machines and an initial competition relationship, thereby obtaining an initial input state s₀ⁱ= [symbol] (G_{J})₀ⁱ, (G_{M})₀ⁱ [symbol] of a scheduling model.

S3: Allow an agent to explore each environment, and repeat the following operations for Tᵢ times for the i^{th} environment (Tᵢ is the number of processes in the i^{th} environment): first input state information sₜ₋₁ⁱ= [symbol] (G_{J})ₜ₋₁ⁱ, (G_{M})ₜ₋₁ⁱ [symbol] of a previous time into the feature extraction network to obtain extracted process features (F_{J}^{(L)})ₜ₋₁ⁱ and machine features (F_{M}^{(L)})ₜ₋₁ⁱ; then extract node features corresponding to each action from (F_{J}^{(L)})ₜ₋₁ⁱ and (F_{M}^{(L)})ₜ₋₁ⁱ, input connection graph features (H_{J}^{(L)})ₜ₋₁ⁱ and (H_{M}^{(L)})ₜ₋₁ⁱ (an average value of each node feature) into the fully connected actor network to generate an action strategy πₜ₋₁ⁱ of the agent in the current step, and sample according to πₜ₋₁ⁱ to generate an action πₜ₋₁ⁱ then the agent uses the action αₜ₋₁ⁱ to interact with the environment, to obtain a state sₜⁱ at a current time, a reward rₜ₋₁ⁱ of the current step and a termination mark doneₜ₋₁ⁱ of this step (if t=Tᵢ): finally, input graph features (H_{J}^{(L)})ₜ₋₁ⁱ and (H_{M}^{(L)})ₜ₋₁ⁱ into the fully connected critic network to calculate a state value, further calculate an advantage function value Aₜ₋₁ⁱ of a corresponding step, save sₜ₋₁ⁱ, αₜ₋₁ⁱ, rₜ₋₁ⁱ, doneₜ₋₁ⁱ, sₜⁱ and Aₜ₋₁ⁱ to a cache pool, and let t←t-1.

S4: Calculate a loss function of a proximal policy optimization (PPO) algorithm according to the data in the cache pool, where the function is defined as:

$$L ( θ ) = {\hat{𝔼}}_{t} [ {L}_{t}^{CLIP} ( θ ) - {c}_{1} {L}_{t}^{VF} ( θ ) + {c}_{2} S [ {π}_{θ} ] ( {s}_{t} ) ] ,$$

$$where$$

$${L}_{t}^{CLIP} ( θ ) = {\hat{𝔼}}_{t} [ min ( \frac{{π}_{θ} ( {a}_{t} \vert {s}_{t} )}{{π}_{{θ}_{old}} ( {a}_{t} \vert {s}_{t} )} {Â}_{t} , clip ( \frac{{π}_{θ} ( {a}_{t} \vert {s}_{t} )}{{π}_{{θ}_{old}} ( {a}_{t} \vert {s}_{t} )} , 1 - ϵ , 1 + ϵ ) {Â}_{t} ) ] ,$$

π_{θ} and π_{θ}_{_{old}} are actually updated strategy and an exploration strategy respectively, ∈ is a truncation coefficient: Lₜ^{VF}(θ) is a mean square error between an estimated state value and a cumulative reward: S[π_{θ}](Sₜ) is the entropy of a strategy in a state sₜ; and c₁ and c₂ are positive coefficients; and update the feature extraction network parameter ω, the actor network parameter θ and the critic network parameter φ based on a gradient descent method.

S5: Determine a number of current training times: if the number of current training times is an integer multiple of Tᵥₐₗᵢ, validate a current strategy on the validation set given in step S1, that is, allow the current strategy π_{θ} to interact with the Nᵥₐₗᵢ environments in the validation set, to generate scheduling solutions (maximum completion times): taking an average value of the scheduling solutions of a scheduler in these environments as a determining standard, if the quality of the current solution is improved compared with that of a previous one, save parameters of the current network; and if the number of current training times is an integer multiple of Tₛₚ, regenerate an environment set for training.

S6: Repeat steps S2 to S5 until the number of training times reaches the preset value Tₑₚ; and finally obtain model parameters ω, θ and φ that are optimized on the current scale problem.

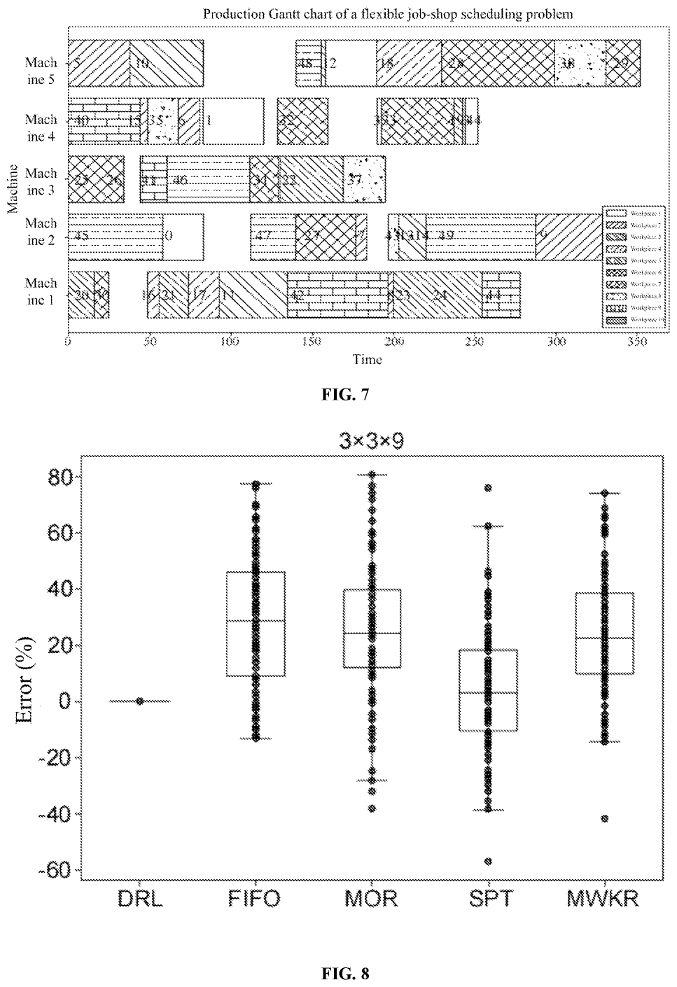

FIG. 7 is a production Gantt chart corresponding to scheduling solutions in a 10×5×50 (representing 10 workpieces, 5 machines and 50 processes, the same below) environment in a flexible job-shop scheduling method based on dual-view graph reinforcement learning according to this embodiment.

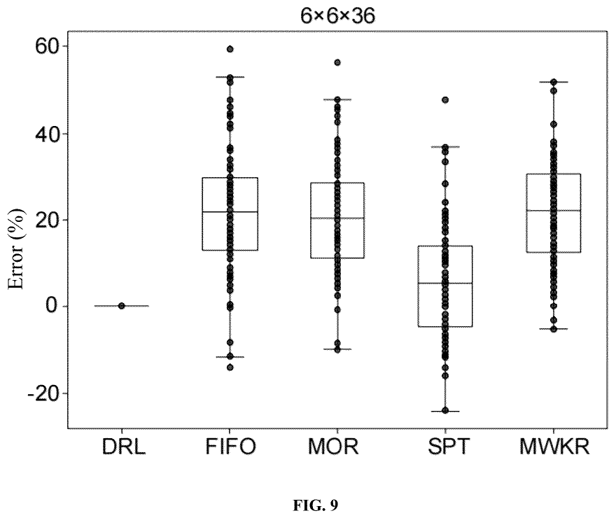

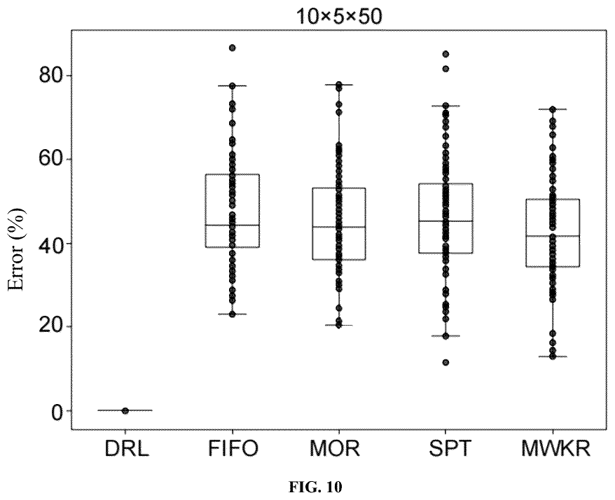

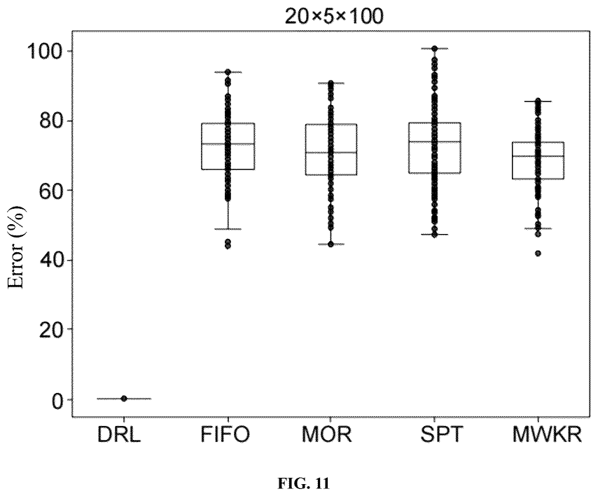

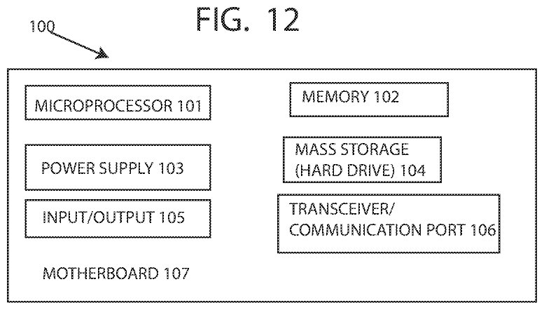

Operation effect diagrams of an example of the flexible job-shop scheduling method based on dual-view graph reinforcement learning according to the present disclosure in four flexible job-shop environments with different scales are shown in FIGS. 8 to 11, where the four different scales are 3×3×9, 6×6×36, 10×5×50 and 20×5×100. The operation effect diagrams show the comparison between the flexible job-shop scheduling method based on dual-view graph reinforcement learning according to the present disclosure and four classical heuristic rules, where the four classical heuristic rules are first in first out (FIFO), most operation remaining (MOR), shortest processing time (SPT), and most work remaining (MWKR). In the operation effect diagrams, the flexible job-shop scheduling method based on dual-view graph reinforcement learning according to the present disclosure is superior to these heuristic rules in solution quality, which fully embodies the effectiveness of the method.

### Embodiment 3

To implement the method corresponding to Embodiment 1 and achieve corresponding functions and technical effects, a flexible job-shop scheduling system is provided below, including:
a flexible job-shop environment generating module, configured to randomly generate a plurality of flexible job-shop environments in a production job-shop according to a preset production target, and construct a plurality of data sets according to parameters of the plurality of flexible job-shop environments, where the data sets are in a one-to-one correspondence with the flexible job-shop environments, and the data sets each are a training set or a validation set;
a scheduling strategy model determining module, configured to construct a scheduling strategy model of the production job-shop based on a Markov decision process;
a network parameter initialization module, configured to perform parameter initialization processing on a feature extraction network, an actor network, and a critic network;
an optimal scheduling plan determining module, configured to optimize the feature extraction network, the actor network and the critic network simultaneously by using the scheduling strategy model and the plurality of data sets, and determine a scheduling plan corresponding to a maximum completion time as an optimal scheduling plan after the completion of the optimization; and
a scheduling module, configured to complete the preset production target based on the optimal scheduling plan.

### Embodiment 4

This embodiment provides an electronic device, including a memory and a processor, where the memory is configured to store a computer program, and the processor runs the computer program to enable the electronic device to implement the flexible job-shop scheduling method according to embodiment 1 or 2. The memory is a readable storage medium.

Embodiments of the description are described in a progressive manner, each embodiment focuses on the difference from other embodiments, and for the same and similar parts between the embodiments, reference may be made to each other. Since the system disclosed in an embodiment corresponds to the method disclosed in another embodiment, the description is relatively simple, and for related parts, reference may be made to the method description.

Specific examples are used herein to explain the principles and implementations of the present disclosure. The foregoing description of the embodiments is merely intended to help understand the method of the present disclosure and its core ideas: besides, various modifications may be made by those of ordinary skill in the art to specific implementations and the scope of application in accordance with the ideas of the present disclosure. In conclusion, the content of the description shall not be construed as limitations to the present disclosure.

1. A flexible job-shop scheduling method, comprising:
randomly generating a plurality of flexible job-shop environments in a production job-shop according to a preset production target, and constructing a plurality of data sets according to parameters of the plurality of flexible job-shop environments, wherein the data sets are in a one-to-one correspondence with the flexible job-shop environments, and the data sets each are a training set or a validation set;
constructing a scheduling strategy model of the production job-shop based on a Markov decision process;
performing parameter initialization processing on a feature extraction network, an actor network, and a critic network;
optimizing the feature extraction network, the actor network and the critic network simultaneously by using the scheduling strategy model and the plurality of data sets, and determining a scheduling plan corresponding to a maximum completion time as an optimal scheduling plan after the completion of the optimization; and
completing the preset production target based on the optimal scheduling plan.

2. The flexible job-shop scheduling method according to claim 1, wherein the optimizing the feature extraction network, the actor network and the critic network simultaneously by using the scheduling strategy model and the plurality of data sets, and determining a scheduling plan corresponding to a maximum completion time as an optimal scheduling plan after the completion of the optimization comprises:
determining an initialized feature extraction network parameter, actor network parameter and critic network parameter as network parameters of a 0^{th} training round;
initializing an evaluated amount of the 0^{th} training round;
letting a number of training rounds be Episode=1;
initializing a cache pool and capacity of the scheduling strategy model;
letting a first iteration number be i=1;
determining any training flexible job-shop environment in a training flexible job-shop environment set as a current training flexible job-shop environment, wherein the training flexible job-shop environment is a flexible job-shop environment corresponding to a training set;
determining a process diagram and a machine competition graph of the current training flexible job-shop environment;
updating the cache pool by using the feature extraction network, the actor network and the critic network according to the process diagram and the machine competition graph;
performing parameter update on the feature extraction network, the actor network and the critic network by using a gradient descent method according to the cache pool; and determining whether the number of training rounds Episode reaches a threshold of round iterations to obtain a first determining result;
determining, if the first determining result is no, whether the first iteration number i is an integer multiple of the number of training flexible job-shop environments to obtain a second determining result;
updating, if the second determining result is no, the current training flexible job-shop environment, increasing a value of the first iteration number i by 1, and returning to the step of determining a process diagram and a machine competition graph of the current training flexible job-shop environment;
determining, if the second determining result is yes, an updated parameter of the feature extraction network, an updated parameter of the actor network and an updated parameter of the critic network as to-be-determined network parameters of an Episode^{th} training round;
determining a current strategy according to the cache pool, validating the current strategy by using a plurality of validation sets, and determining an evaluated amount of the Episode^{th} training round;
determining a network parameter of the Episode^{th} training round according to the evaluated amount of the Episode^{th} training round, an evaluated amount of an (Episode-1)^{th} training round, a to-be-determined network parameter of the Episode^{th} training round and a network parameter of the (Episode-1)^{th} training round; updating the training flexible job-shop environment set; increasing the value of the number Episode of training rounds by 1, increasing the value of the first iteration number i by 1, and returning to the step of determining any training flexible job-shop environment in a training flexible job-shop environment set as a current training flexible job-shop environment; and
determining, if the first determining result is yes, that the optimization on the feature extraction network, the actor network and the critic network is completed, and determining the scheduling plan corresponding to the maximum completion time as the optimal scheduling plan.

3. The flexible job-shop scheduling method according to claim 2, wherein the process diagram is used to describe processes capable of being completed in the flexible job-shop environment, process features capable of being completed in the flexible job-shop environment, a sequence of processes of a same workpiece, and a sequence of a plurality of processes completed on a same machine when the same workpiece is produced; and
wherein the process feature comprises a scheduling mark of a process in a current state, an estimated lower bound of a completion time, a processing time span, an average processing time, a queuing time, a number of remaining processes of a workpiece, a remaining workload of the workpiece, and a number of machinable machines.

4. The flexible job-shop scheduling method according to claim 2, wherein the machine competition graph comprises a plurality of machines in a flexible job-shop environment, machine features of the plurality of machines in the flexible job-shop environment, and a competition relationship between the plurality of machines; and
the machine feature comprises a number of machinable candidates of a machine in the current state, a total number of machinable processes, an average processing time, a queuing time, an idle time, and a current queue length.

5. The flexible job-shop scheduling method according to claim 2, wherein the updating the cache pool by using the feature extraction network, the actor network and the critic network according to the process diagram and the machine competition graph comprises:
initializing state information of an 0^{th} iteration;
initializing a process feature map and a machine feature map;
letting a second iteration number be t=1;
acquiring state information in a (t-1)^{th} iteration;
inputting the state information in the (t-1)^{th} iteration into the feature extraction network to obtain process features and machine features;
updating the process feature map by using the process features;
updating the machine feature map by using the machine features;
inputting the process feature map and the machine feature map into the actor network to obtain a scheduling strategy in the (t-1)^{th} iteration;
sampling the scheduling strategy in the (t-1)^{th} iteration to obtain an action when the (t-1)^{th} iteration is generated;
using the action in the (t-1)^{th} iteration to interact with the current training flexible job-shop environment, to obtain an iteration reward and state information in the t^{th} iteration;
inputting the process feature map and the machine feature map into the critic network to obtain an advantage function value;
adding the state information in the (t-1)^{th} iteration, the action in the (t-1)^{th} iteration, the iteration reward, the state information in the t^{th} iteration and the advantage function value to the cache pool;
determining whether the second iteration number t satisfies the current training flexible job-shop environment, to obtaining a third determining result;
adding, if the third determining result is yes, the total number of the processes of the current training flexible job-shop as a termination mark to the cache pool; and
increasing, if the third determining result is no, the value of the second iteration number t by 1, and returning to the step of acquiring state information in the (t-1)^{th} iteration.

6. The flexible job-shop scheduling method according to claim 2, wherein the determining a current strategy according to the cache pool, validating the current strategy by using a plurality of validation sets, and determining an evaluated amount of the Episode^{th} training round comprises:
allowing the current strategy to interact with a plurality of validating flexible job-shop environments in a validating flexible job-shop environment set to obtain a maximum completion time corresponding to each validating flexible job-shop environment, wherein the validating flexible job-shop environment is a flexible job-shop environment corresponding to the validation set; and
determining an average value of a plurality of maximum completion times corresponding to the validating flexible job-shop environment set as an evaluated amount of the Episode^{th} training round.

7. The flexible job-shop scheduling method according to claim 2, wherein the determining a network parameter of the Episode^{th} training round according to the evaluated amount of the Episode^{th} training round, an evaluated amount of an (Episode-1)^{th} training round, a to-be-determined network parameter of the Episode^{th} training round and a network parameter of the (Episode-1)^{th} training round comprises:
determining whether the evaluated amount of the Episode^{th} training round is greater than that of the (Episode-1)^{th} training round to obtain a fourth determining result; and
determining, if the fourth determining result is yes, the to-be-determined network parameter of the Episode^{th} training round as a network parameter of the Episode^{th} training round; or
determining, if the fourth determining result is no, the network parameter of the (Episode-1)^{th} training round as a network parameter of the Episode^{th} training round.

8. A flexible job-shop scheduling system, comprising:
a flexible job-shop environment generating module, configured to randomly generate a plurality of flexible job-shop environments in a production job-shop according to a preset production target, and construct a plurality of data sets according to parameters of the plurality of flexible job-shop environments, wherein the data sets are in a one-to-one correspondence with the flexible job-shop environments, and the data sets each are a training set or a validation set;
a scheduling strategy model determining module, configured to construct a scheduling strategy model of the production job-shop based on a Markov decision process;
a network parameter initialization module, configured to perform parameter initialization processing on a feature extraction network, an actor network, and a critic network;
an optimal scheduling plan determining module, configured to optimize the feature extraction network, the actor network and the critic network simultaneously by using the scheduling strategy model and the plurality of data sets, and determine a scheduling plan corresponding to a maximum completion time as an optimal scheduling plan after the completion of the optimization; and
a scheduling module, configured to complete the preset production target based on the optimal scheduling plan.

9. An electronic device, comprising a memory and a processor, wherein the memory is configured to store a computer program, and the processor runs the computer program to enable the electronic device to implement the flexible job-shop scheduling method according to claim 1.

10. (canceled)

11. The electronic device according to claim 9, wherein the optimizing the feature extraction network, the actor network and the critic network simultaneously by using the scheduling strategy model and the plurality of data sets, and determining a scheduling plan corresponding to a maximum completion time as an optimal scheduling plan after the completion of the optimization comprises:
determining an initialized feature extraction network parameter, actor network parameter and critic network parameter as network parameters of a 0^{th} training round;
initializing an evaluated amount of the 0^{th} training round;
letting a number of training rounds be Episode=1;
initializing a cache pool and capacity of the scheduling strategy model;
letting a first iteration number be i=1;
determining any training flexible job-shop environment in a training flexible job-shop environment set as a current training flexible job-shop environment, wherein the training flexible job-shop environment is a flexible job-shop environment corresponding to a training set;
determining a process diagram and a machine competition graph of the current training flexible job-shop environment;
updating the cache pool by using the feature extraction network, the actor network and the critic network according to the process diagram and the machine competition graph;
performing parameter update on the feature extraction network, the actor network and the critic network by using a gradient descent method according to the cache pool; and determining whether the number of training rounds Episode reaches a threshold of round iterations to obtain a first determining result;
determining, if the first determining result is no, whether the first iteration number i is an integer multiple of the number of training flexible job-shop environments to obtain a second determining result;
updating, if the second determining result is no, the current training flexible job-shop environment, increasing a value of the first iteration number i by 1, and returning to the step of determining a process diagram and a machine competition graph of the current training flexible job-shop environment;
determining, if the second determining result is yes, an updated parameter of the feature extraction network, an updated parameter of the actor network and an updated parameter of the critic network as to-be-determined network parameters of an Episode^{th} training round;
determining a current strategy according to the cache pool, validating the current strategy by using a plurality of validation sets, and determining an evaluated amount of the Episode^{th} training round;
determining a network parameter of the Episode^{th} training round according to the evaluated amount of the Episode^{th} training round, an evaluated amount of an (Episode-1)^{th} training round, a to-be-determined network parameter of the Episode^{th} training round and a network parameter of the (Episode-1)^{th} training round; updating the training flexible job-shop environment set; increasing the value of the number Episode of training rounds by 1, increasing the value of the first iteration number i by 1, and returning to the step of determining any training flexible job-shop environment in a training flexible job-shop environment set as a current training flexible job-shop environment; and
determining, if the first determining result is yes, that the optimization on the feature extraction network, the actor network and the critic network is completed, and determining the scheduling plan corresponding to the maximum completion time as the optimal scheduling plan.

12. The electronic device according to claim 11, wherein the process diagram is used to describe processes capable of being completed in the flexible job-shop environment, process features capable of being completed in the flexible job-shop environment, a sequence of processes of a same workpiece, and a sequence of a plurality of processes completed on a same machine when the same workpiece is produced; and
wherein the process feature comprises a scheduling mark of a process in a current state, an estimated lower bound of a completion time, a processing time span, an average processing time, a queuing time, a number of remaining processes of a workpiece, a remaining workload of the workpiece, and a number of machinable machines.

13. The electronic device according to claim 11, wherein the machine competition graph comprises a plurality of machines in a flexible job-shop environment, machine features of the plurality of machines in the flexible job-shop environment, and a competition relationship between the plurality of machines; and
the machine feature comprises a number of machinable candidates of a machine in the current state, a total number of machinable processes, an average processing time, a queuing time, an idle time, and a current queue length.

14. The electronic device according to claim 11, wherein the updating the cache pool by using the feature extraction network, the actor network and the critic network according to the process diagram and the machine competition graph comprises:
initializing state information of an 0^{th} iteration;
initializing a process feature map and a machine feature map;
letting a second iteration number be t=1;
acquiring state information in a (t-1)^{th} iteration;
inputting the state information in the (t-1)^{th} iteration into the feature extraction network to obtain process features and machine features;
updating the process feature map by using the process features;
updating the machine feature map by using the machine features;
inputting the process feature map and the machine feature map into the actor network to obtain a scheduling strategy in the (t-1)^{th} iteration;
sampling the scheduling strategy in the (t-1)^{th} iteration to obtain an action when the (t-1)^{th} iteration is generated;
using the action in the (t-1)^{th} iteration to interact with the current training flexible job-shop environment, to obtain an iteration reward and state information in the t^{th} iteration;
inputting the process feature map and the machine feature map into the critic network to obtain an advantage function value;
adding the state information in the (t-1)^{th} iteration, the action in the (t-1)^{th} iteration, the iteration reward, the state information in the t^{th} iteration and the advantage function value to the cache pool;
determining whether the second iteration number t satisfies the current training flexible job-shop environment, to obtaining a third determining result;
adding, if the third determining result is yes, the total number of the processes of the current training flexible job-shop as a termination mark to the cache pool; and
increasing, if the third determining result is no, the value of the second iteration number t by 1, and returning to the step of acquiring state information in the (t-1)^{th} iteration.

15. The electronic device according to claim 11, wherein the determining a current strategy according to the cache pool, validating the current strategy by using a plurality of validation sets, and determining an evaluated amount of the Episode^{th} training round comprises:
allowing the current strategy to interact with a plurality of validating flexible job-shop environments in a validating flexible job-shop environment set to obtain a maximum completion time corresponding to each validating flexible job-shop environment, wherein the validating flexible job-shop environment is a flexible job-shop environment corresponding to the validation set; and
determining an average value of a plurality of maximum completion times corresponding to the validating flexible job-shop environment set as an evaluated amount of the Episode^{th} training round.

16. The electronic device according to claim 11, wherein the determining a network parameter of the Episode^{th} training round according to the evaluated amount of the Episode^{th} training round, an evaluated amount of an (Episode-1)^{th} training round, a to-be-determined network parameter of the Episode^{th} training round and a network parameter of the (Episode-1)^{th} training round comprises:
determining whether the evaluated amount of the Episode^{th} training round is greater than that of the (Episode-1)^{th} training round to obtain a fourth determining result; and
determining, if the fourth determining result is yes, the to-be-determined network parameter of the Episode^{th} training round as a network parameter of the Episode^{th} training round; or
determining, if the fourth determining result is no, the network parameter of the (Episode-1)^{th} training round as a network parameter of the Episode^{th} training round.

17. The electronic device according to claim 9, wherein the memory is a readable storage medium.

18. The electronic device according to claim 11, wherein the memory is a readable storage medium.

19. The electronic device according to claim 12, wherein the memory is a readable storage medium.

20. The electronic device according to claim 13, wherein the memory is a readable storage medium.

21. The electronic device according to claim 14, wherein the memory is a readable storage medium.
